(19) United States
(12) Patent Application Publication
(10) Pub. No.: US 2022/0241742 A1
(43) Pub. Date: Aug. 4, 2022

(54) AGITATION DEVICE AND AGITATION METHOD

(71) Applicant: CASIO COMPUTER CO., LTD., Tokyo (JP)

(72) Inventors: Eiichi HARADA, Tokyo (JP); Fumihiro OSAKABE, Tokyo (JP)

(21) Appl. No.: 17/591,055

(22) Filed: Feb. 2, 2022

(30) Foreign Application Priority Data
Feb. 4, 2021 (JP) 2021-016194

(51) Int. Cl. B01F 29/60; B01F 23/50; B01F 23/53; B01F 29/00; B01F 35/213; B01F 35/221; B01F 35/50; C09D 11/037

(52) U.S. Cl. CPC B01F 29/60; B01F 23/511; B01F 23/53; B01F 29/4033; B01F 2101/35; B01F 35/221422; B01F 35/514; C09D 11/037; B01F 35/213

(57) ABSTRACT

An agitation device includes a holder that holds a cartridge containing a liquid on a placement surface angled with respect to a horizontal plane; and a rotator that rotates the holder to agitate the liquid.

### CROSS-REFERENCE TO RELATED APPLICATIONS

This application claims priority and benefit of Japanese Patent Application No. 2021-016194, filed on Feb. 4, 2021, the entire disclosure of which is incorporated herein by reference in its entirety.

### TECHNICAL FIELD

The present disclosure relates to an agitation device and an agitation method.

### BACKGROUND

Liquids used for printing, such as inks, are a mixture in which a component(s) is dispersed in a medium. The liquid in its intended state of use contains the component evenly or nearly evenly dispersed in the medium.

However, when the relative density of the component is greater than the relative density of the medium, the component and the medium gradually separate in the liquid kept standing. Eventually, the component sediments at the bottom of the container. Such a liquid may clog nozzles for ejecting the liquid and thereby causes poor ejection. Further, the ejected liquid may contain a greater proportion of component, which results in uneven ink densities.

In nail printing, a white undercoat ink may be applied before printing designs. The undercoat ink contains a white ingredient component having a large relative density (e.g., titanium oxide), which is likely to sediment. Undercoat printing is a known printing process used in design printing including nail printing.

When printing is performed with an ink in which the sedimentation has proceeded, the ink may cause uneven colors or stripes in prints, or may prevent proper ink ejection by clogging the nozzles. As a result, printing quality may be deteriorated.

To deal with the issue, JP2007-331307A discloses a configuration for agitating ink (liquid) in a cartridge mounted on a carriage by reciprocating the carriage when recording is not performed.

### SUMMARY

The present disclosure relates to an agitation device including: a holder that holds a cartridge containing a liquid on a placement surface angled with respect to a horizontal plane; and a rotator that rotates the holder to agitate the liquid.

### BRIEF DESCRIPTION OF THE DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a perspective external view of main parts of an agitation device in an embodiment;

FIG. 2 is a lateral view of main parts of a holder and a rotator constituting the agitation device in FIG. 1;

FIG. 3 is a cross section of the main parts along the III-III line in FIG. 2;

FIG. 4 is a perspective view of a modification of a cartridge set on the agitation device in the embodiment;

FIG. 5A is a perspective view of a modification of the cartridge set on the agitation device in the embodiment;

FIG. 5B is a cross section of the main part of the cartridge shown in FIG. 5A;

FIG. 6 is a top view of a placing stand on which the cartridge is set;

FIG. 7A is a lateral view of the placing stand on which the cartridge is set;

FIG. 7B is a lateral view of the placing stand shown in FIG. 7A rotated through 180 degrees;

FIG. 8A is a lateral view of the placing stand with the placing surface angled at 30 degrees;

FIG. 8B is a lateral view of the placing stand shown in FIG. 8A rotated through 180 degrees;

FIG. 8C shows a schematic diagram to explain a swing angle when the inclination angle of the placing surface is 30 degrees;

FIG. 9A is a lateral view of the placing stand with the placing surface angled at 45 degrees;

FIG. 9B is a lateral view of the placing stand shown in FIG. 9A rotated through 180 degrees;

FIG. 9C shows a schematic diagram to explain the swing angle when the inclination angle of the placing surface is 45 degrees;

FIG. 10A is a lateral view of the placing stand with the placing surface angled at 60 degrees;

FIG. 10B is a lateral view of the placing stand shown in FIG. 10A rotated through 180 degrees;

FIG. 10C shows a schematic diagram to explain the swing angle when the inclination angle of the placing surface is 60 degrees;

FIG. 11A is a lateral view of the placing stand with the placing surface angled at 90 degrees;

FIG. 11B is a lateral view of the placing stand shown in FIG. 11A rotated through 180 degrees;

FIG. 12 is a diagram showing the relationship between the inclination angle of the placing surface and the swing angle;

FIG. 13 is a diagram to explain an experimental method for checking agitation effects;

FIG. 14 is a graph showing the relationship between the standing time and the change in whiteness;

FIG. 15 is a graph showing the relationship between the agitation time and the change in whiteness for different standing times;

FIG. 16 is a graph showing the relationship between the rotation speed and the required agitation time;

FIG. 17 is a graph showing the relationship between the agitation time and the change in whiteness for different rotation speeds;

FIG. 18 is a side section of main parts of the agitation device in operation in the embodiment;

FIG. 19 is a cross section of the main parts of the holder holding the cartridge before agitation; and

FIG. 20 is a cross section of the main parts of the holder holding the cartridge after agitation.

### DESCRIPTION OF EMBODIMENTS

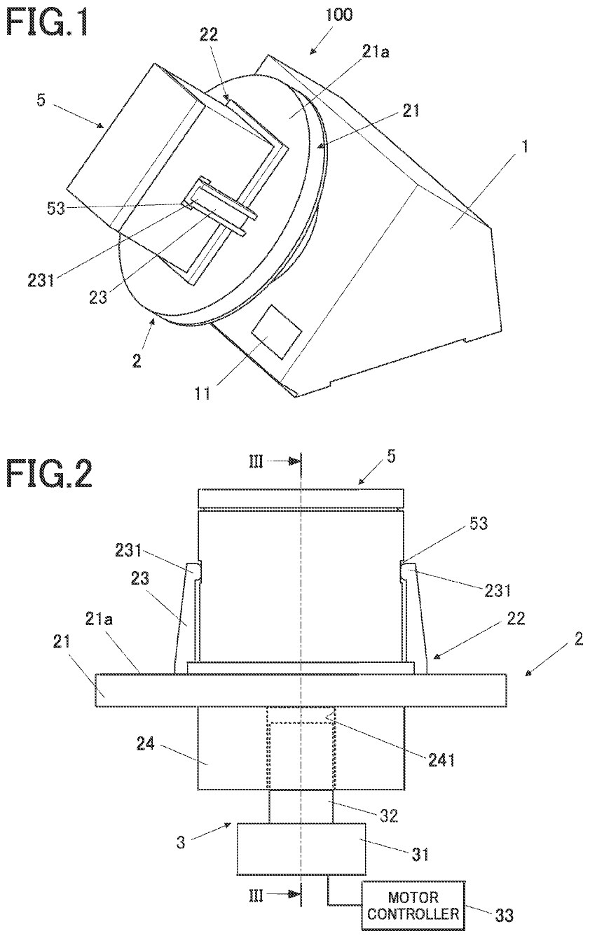

Hereinafter, an embodiment of the agitation device and agitation method according to the present invention is described with reference to FIG. 1 to FIG. 20.

The embodiment described below is provided with various limitations technically preferable for carrying out the present invention. However, the scope of the present invention is not limited to the embodiment below or illustrated examples.

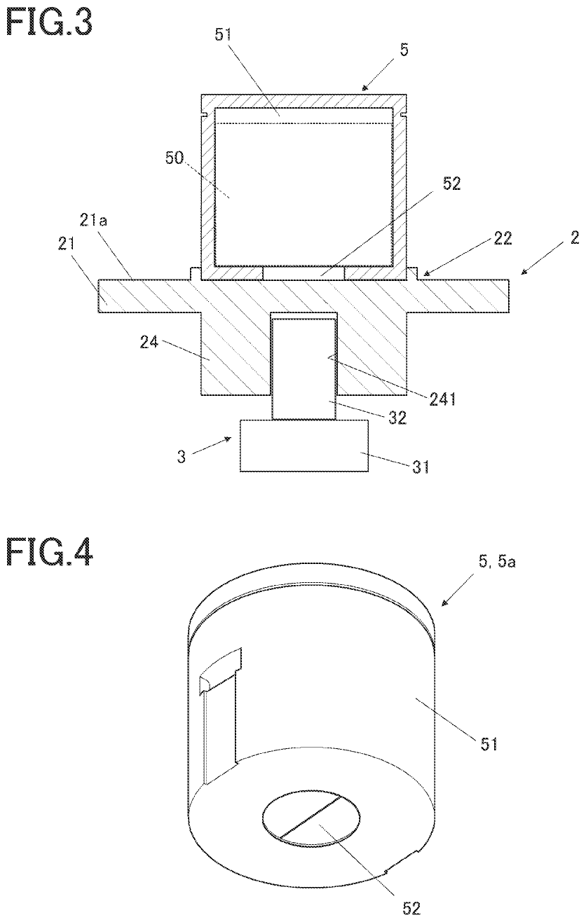

FIG. 1 is a perspective external view of main parts of the agitation device according to this embodiment. FIG. 2 is a lateral view of main parts of a holder and a rotator constituting the agitation device in FIG. 1. FIG. 3 is a cross section of the main parts along the III-III line in FIG. 2.

As shown in FIG. 1, the agitation device 100 includes a main body 1, a holder 2, and a rotator 3.

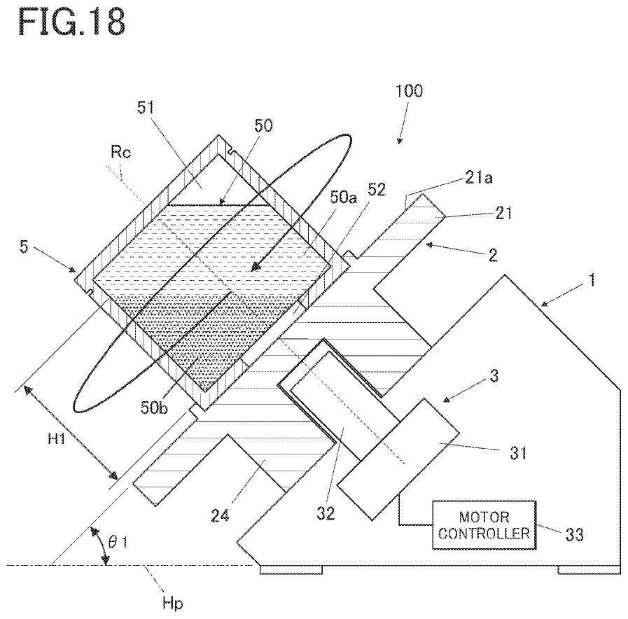

The main body 1 is a box-shaped base stand placed on a flat surface, such as a table. In this embodiment, the main body 1 is placed on a horizontal surface Hp, as shown in FIG. 18. The shape of the main body 1 is not limited to the illustrated example.

The main body 1 houses a motor 31 that constitutes the rotator 3, a motor controller 33 that controls the operation of the motor 31 (at least one processor, such as a driving control circuit, see FIG. 2), and a not-illustrated power source that supplies power to the motor 31 and so forth. The power source is a power-source circuit, for example. The power source may receive power from a battery housed inside the main body 1 or from outside through an interface.

An operation receiver 11 is mounted on the external surface of the main body 1. In this embodiment, the operation receiver 11 is mounted on the upper surface of the main body 1, as shown in FIG. 1. The configuration of the operation receiver 11 is not limited to a specific one. The operation receiver 11 may include operation buttons or may be a touchscreen capable of receiving touch operations.

In this embodiment, a user can switch on/off the agitation device 100 and do various settings by operating the operation receiver 11.

The operation receiver 11 in this embodiment also serves as a setting receiver capable of setting at least either the rotation speed at which the rotator 3 (described later) rotates the holder 2 or the agitation time. Herein, the rotation speed corresponds to the rotation speed of the motor 31 that rotates the holder 2. The rotation speed can be indicated by a rotation rate per minute (rpm), for example. The agitation time in this embodiment is a time during which the holder 2 is rotated (i.e., the time during which the motor 31 rotates).

The agitation device 100 may receive various settings and operations through communication with terminal devices (e.g., smartphones) and other not-illustrated external devices. In such a case, the main body 1 houses a communicator capable of sending and receiving signals to and from the external devices, for example.

The main body 1 may be further provided with a display or an indicator on the top surface or the lateral surface thereof for monitoring the operation state.

The holder 2 includes a placing stand 21 and a leg 24, and holds the cartridge 5 that contains an ink 50 as a liquid.

The placing stand 21 in this embodiment has a disc shape. The upper surface of the placing stand 21 constitutes the placing surface 21a on which the cartridge 5 is placed. The placing stand 21 is rotatable along its surface at the center of the disc (rotation center Rc, see FIG. 18, etc) by the rotator 3, which is described later. The shape of the placing stand 21 is not limited to a disc shape but may be a polygon shape, such as a square. The placing stand 21 with a polygon shape is also configured to be rotatable along its surface at the center of the placing stand 21 as the rotation center Rc (center of gravity).

The placing stand 21 is set such that the placing surface 21a is angled at a specific angle with respect to the horizontal surface Hp (see FIG. 18 etc). In this embodiment, the angle of the placing surface 21a to the horizontal surface Hp (inclination angle θ1, see FIG. 18) is 45 degrees.

On the placing surface 21a, a cartridge fastener 22 including fastening arms 23 is provided.

The fastening arms 23 hold the lateral surface of the cartridge 5, thereby preventing the cartridge 5 from rattling on the placing surface 21a or falling off the placing stand 21 when the placing stand 21 rotates.

In this embodiment, claws 231 are formed on the respective leading ends of the fastening arms 23, as shown in FIG. 2. The claws 231 hold the lateral surface of the cartridge 5 to fasten the cartridge 5. Recesses 53 are formed on the lateral surface of the cartridge 5 at positions corresponding to the claws 231, so as to be caught by the claws 231.

The shape of the fastening arms 23 is not limited to a specific shape. For example, the fastening arms 23 may have a nonslip structure on its surface contacting the cartridge 5, in order to fasten the cartridge 5. In the case, the cartridge 5 may not have the recesses 53 or the like on its lateral surface.

Further, the cartridge fastener 22 may not have the fastening arms 23. For example, the cartridge fastener 22 itself may have a frame shape or a recess shape so that the cartridge 5 is inserted into the cartridge fastener 22 and fastened.

The leg 24 has a cylindrical shape and is provided at the back surface side of the placing stand 21 (the side opposite the placing surface 21a). The leg 24 may be integrated with the placing stand 21, or may be separate from the placing stand 21 and fixed to the back surface side of the placing stand 21.

Around the center axis of the cylindrical part of the leg 24, a recess 241 is formed.

In the recess 241, a shaft 32 is inserted. The shaft 32 is connected to the motor 31 of the rotator 3. The shaft 32 is fixed by being pressed into the recess 241 or fixed by a not-illustrated member. When the motor 31 rotates the shaft 32, the entire holder 2 including the leg 24 is rotated.

The rotator 3 is configured to rotate the holder 2.

As shown in FIG. 2 and FIG. 3, the rotator 3 includes the motor 31 and the shaft 32 connected to the motor 31. The motor 31 is supplied with power by the power source. The movement of the motor 31 is controlled by the motor controller 33 (e.g., driving control circuit).

The shaft 32 is attached to the leg 24 of the holder 2, as described above. The rotation axis of the shaft 32 corresponds to the rotation center Rc (see FIG. 18 etc.) of the holder 2 (placing stand 21 of the holder 2). Accordingly, the holder 2 (placing stand 21 of the holder 2) rotates at the rotation center Rc as the motor 31 rotates.

Outputs of the motor 31 are adjustable in this embodiment. The motor 31 moves in accordance with the setting received by the operation receiver 11 (setting receiver). Thus, in this embodiment, agitation conditions, such as the rotation speed at which the rotator 3 rotates the holder 2 (the placing stand 21 of the holder 2) and the agitation time, can be set as desired by operating the operation receiver 11. The motor controller 33 controls the motor 31 to rotate the holder 2 (the placing stand 21 of the holder 2) at a determined desired rotation speed for a determined desired period of time.

The rotation direction may be clockwise or counterclockwise. The clockwise rotation and counterclockwise rotation may be switched randomly, for example.

In this embodiment, the cartridge 5 to be set on the agitation device 100 for agitation may be a cartridge-integrated printing head that includes a container 51 that contains the ink 50 as the liquid and an ink ejector 52 that ejects the ink 50 contained in the container 51 in printing.

The cartridge 5 is not limited to the container 51 integrated with the ink ejector 52. For example, a cartridge with a container may be separately formed from the head part that ejects ink, and in printing, the cartridge may be connected to the head part via a supply tube. In the case, only the cartridge part containing the ink is set on the agitation device 100 and subject to agitation.

The ink 50 as the liquid in this embodiment is a white or whitish-color undercoat ink (e.g., whitish pink or blue). The ink 50 includes, for example, water as a medium 50a and titanium oxide as a component 50b (see FIG. 18, etc.).

For example, in printing designs on fingernails, the undercoat ink is applied to nails before printing the nail designs with color inks. The undercoating can increase ink color development and enables beautifully finished printing (nail printing).

The cartridge 5 is not limited to the one that contains the ink 50 (e.g., undercoat ink) as the liquid. The cartridge 5 may be any cartridge containing a liquid in which the relative density of the component 50b is greater than the relative density of the medium 50a and in which the component 50b sediments as the cartridge is left standing.

The shape of the cartridge 5 is not limited to the illustrated example.

Although FIG. 1 shows the cuboid cartridge 5 as an example, the entire cartridge 5 (5a) may be cylindrical, as shown in FIG. 4.

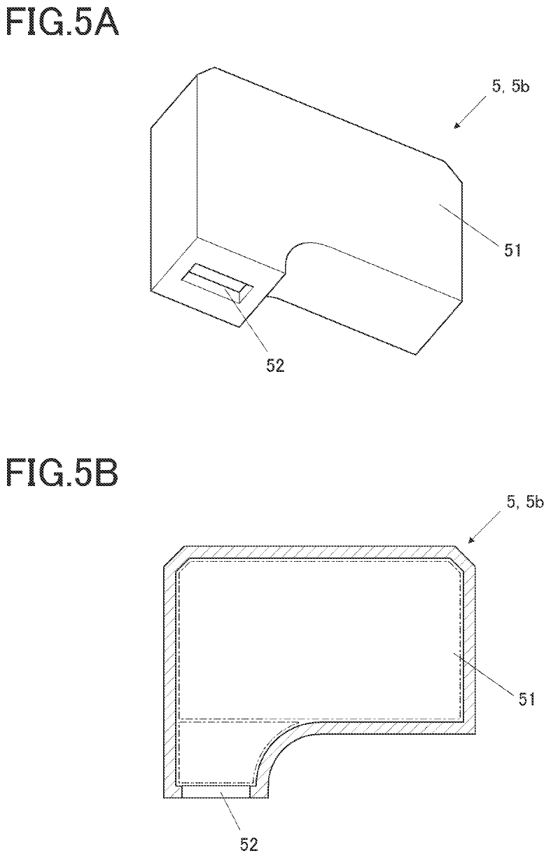

The cartridge 5 (5a) may have a protruding ink ejector 52 formed at the lower part of the cuboid container 51, as shown in FIG. 5A, FIG. 5B.

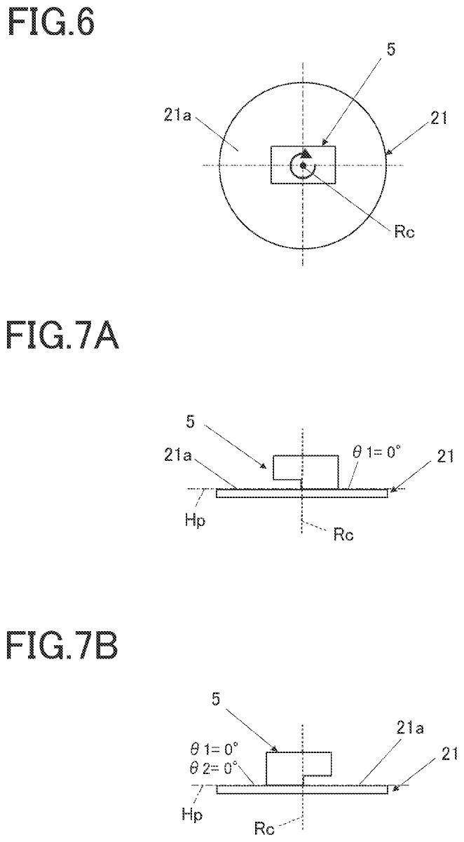

Next, an agitation method in this embodiment is described with reference to FIG. 6 to FIG. 20.

In performing the agitation process with the agitation device 100 in this embodiment, the cartridge 5 that contains the ink 50 to be agitated is mounted and held on the placing surface 21a of the holder 2 and fastened with the fastening arms 23 to avoid rattling. The placing surface 21a is angled at a predetermined angle with respect to the horizontal surface Hp.

In this embodiment, the predetermined angle is 45 degrees or degrees close to 45 degrees, as described above. The angle (predetermined angle) of the placing surface 21a to the horizontal surface Hp is called the inclination angle θ1. The inclination angle θ1 in the range of 0<θ1<90 can yield an agitation effect. Especially, the inclination angle θ1 at 45 degrees or close to 45 degrees can yield a high agitation effect and is therefore preferable.

The high agitation effect with the inclination angle θl around 45 degrees is explained with reference to FIG. 6 to FIG. 12.

FIG. 6 is a top view of the placing stand 21 on which the cartridge 5 is set.

In FIG. 6 to FIG. 11B, the cartridge 5 is illustrated as being placed approximately at the center of the placing stand 21. The position of the cartridge 5, however, is not limited to the illustrated position. For example, the cartridge 5 may be placed on either end part of the placing surface 21a of the placing stand 21 (e.g., near the disc edge). In the case, the cartridge fastener 22 including the fastening arms 23 is provided at the position corresponding to the position of the cartridge 5.

FIG. 7A is a lateral view of the placing stand 21 on which the cartridge 5 is set. FIG. 7B is a lateral view of the placing stand 21 shown in FIG. 7A rotated through 180 degrees.

In FIG. 7A to FIG. 11B, the cartridge 5 (5b) set on the placing stand 21 has an asymmetrical shape in the lateral direction, as shown in FIGS. 5A, 5B, so that the orientation of the cartridge 5 is recognizable when the placing stand 21 is rotated through 180 degrees. The shape of the cartridge 5 to be set on the placing stand 21 is not limited to the illustrated example. The shape of the cartridge 5 (5a) may be the shape shown in FIG. 1 or FIG. 4.

FIGS. 7A, 7B show the case where the angle (inclination angle θ1) of the placing surface 21a to the horizontal surface Hp is 0 (zero) degree.

In the case, the placing surface 21a merely rotates horizontally. The angle at which the cartridge 5 on the placing surface 21a is swung/shaken (swing angle θ2) is also 0 degree, as shown in FIG. 7B.

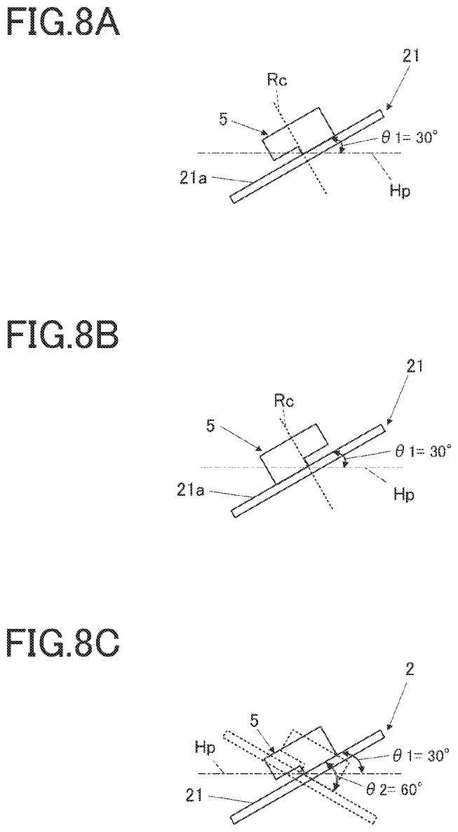

FIGS. 8A to 8C show the case where the angle of the placing surface 21a to the horizontal surface Hp (inclination angle θ1) is 30 degrees.

In the case, when the placing surface 21a rotates, the cartridge 5 on the placing surface 21a is swung like a seesaw along with the rotation, as shown in FIGS. 8A, 8B. In the case where the inclination angle θ1 is 30 degrees, the angle at which the cartridge 5 is swung (swing angle θ2) is 60 degrees, as shown in FIG. 8C.

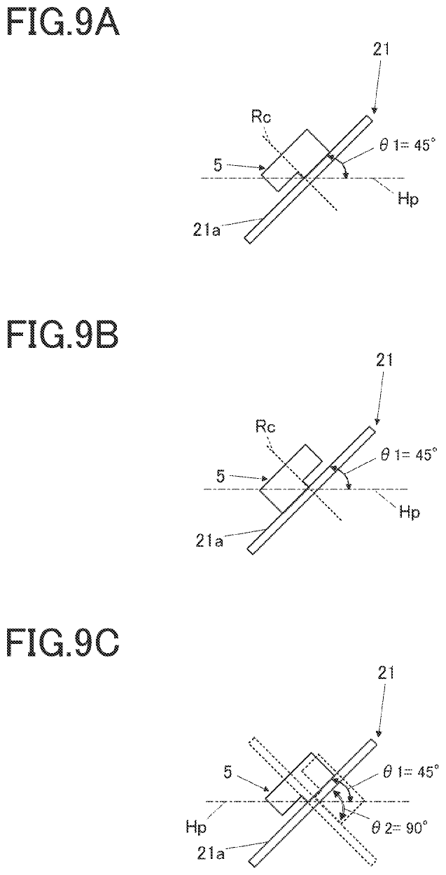

FIGS. 9A to 9C show the case where the angle (inclination angle θ1) of the placing surface 21a to the horizontal surface Hp is 45 degrees.

In the case, when the placing surface 21a rotates, the cartridge 5 on the placing surface 21a is swung like a seesaw along with the rotation, as shown in FIGS. 9A, 9B. In the case where the inclination angle θ1 is 45 degrees, the angle at which the cartridge 5 is swung (swing angle θ2) is 90 degrees, as shown in FIG. 9C.

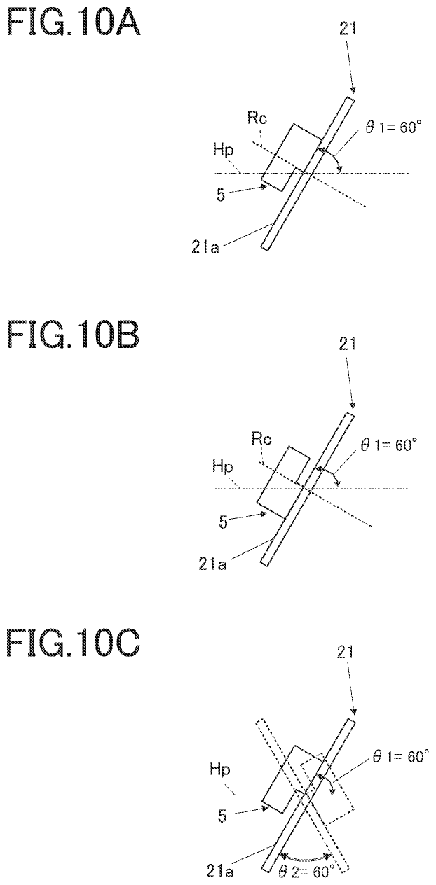

FIGS. 10A to 10C show the case where the angle (inclination angle θ1) of the placing surface 21a to the horizontal surface Hp is 60 degrees.

In the case, when the placing surface 21a rotates, the cartridge 5 on the placing surface 21a is swung like a seesaw along with the rotation, as shown in FIGS. 10A, 10B. In the case where the inclination angle θ1 is 60 degrees, the swing angle θ2 is 60 degrees, as shown in FIG. 10C.

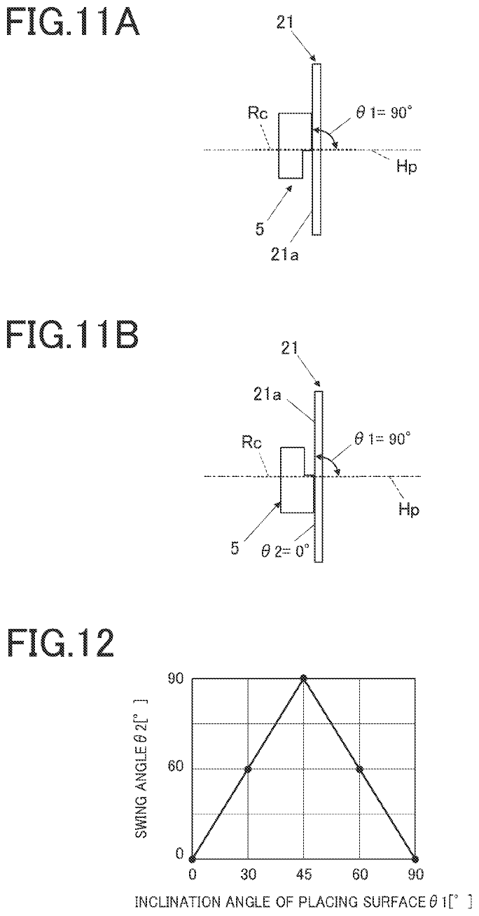

FIGS. 11A, 11B show the case where the angle (inclination angle θ1) of the placing surface 21a to the horizontal surface Hp is 90 degrees.

In the case, the placing surface 21a merely rotates on a plane perpendicular to the horizontal surface Hp. The swing angle θ2 is 0 degree as shown in FIG. 11B, as with the case shown in FIG. 7B where the inclination angle θ1 is 0 degree.

FIG. 12 is a diagram showing the relationship between the inclination angle 81 of the placing surface 21a and the swing angle θ2.

As shown in FIG. 12, the swing angle θ2 is at its maximum of 90 degrees when the inclination angle θ1 of the placing surface 21a is 45 degrees.

The liquid (the ink 50 in this embodiment) in the cartridge 5 can therefore be sufficiently agitated by the rotation and swinging. Even when the component 50b (titanium oxide in this embodiment) has separated from the medium 50a (water or the like in this embodiment) and sedimented, the component 50b can be adequately redispersed.

The cartridge 5 is set on the placing surface 21a of the holder 2, and the agitation conditions are input and set with the operation receiver 11. In this embodiment, the agitation conditions include the rotation speed of the placing surface 21a in agitation (in this embodiment, the rotation speed at which the motor 31 rotates the placing surface 21a) and the agitation time, for example. The agitation conditions are not limited to these examples. For example, the rotation direction may also be set as an agitation condition.

Setting of the agitation conditions is described with reference to FIG. 13 to FIG. 17.

It is preferable that the agitation conditions be set appropriately on the basis of the degree of sedimentation in the liquid (in this embodiment, the ink 50).

In this embodiment, at least either the rotation speed at which the rotator 3 rotates the holder 2 (the placing surface 21a of the holder 2) or the agitation time is determined on the basis of the standing time of the ink 50 as the liquid.

The applicant performed experiments to check the agitation effects with different agitation conditions (herein, the rotation speed and the agitation time) and different standing times of the cartridge 5.

FIG. 13 is a diagram to explain the experimental method for checking agitation effects.

In FIG. 13, P1 is the initial point of time at which the component in the liquid ink 50 is completely dispersed and the ink 50 is in the stable dispersion state, as a result of manually shaking the cartridge 5. The ink 50 in the state of the point P1 allows proper and appropriate printing density for printing. P2 is the agitation start point at which a predetermined standing time has elapsed and the agitation process starts. P3 is the redispersion point of time at which the component is redispersed in the liquid ink 50 and the ink 50 is in the stable dispersion state.

At the initial point P1 and at the agitation start point P2, the cartridge 5 was set on a printing device and printing was performed. After the agitation start point P2, the cartridge 5 was set on the printing device and printing was performed every 30 seconds passed. In FIG. 13, dashed line circles indicate the points of time at which printing was performed. At each of the points, the whiteness of the printing result was measured using a not-illustrated whiteness measurer.

As shown in FIG. 13, the period of time between the agitation start point P2 and the redispersion point P3 is the required agitation time that is required for redispersion in the liquid. The agitation time starting from the agitation start point P2 is the accumulated agitation time.

In the following description, the terms including “whiteness”, “initial point P1”, “agitation start point P2”, “redispersion point P3”, “standing time”, “required agitation time”, and “accumulated agitation time” are used in the same meaning as in the description of FIG. 13.

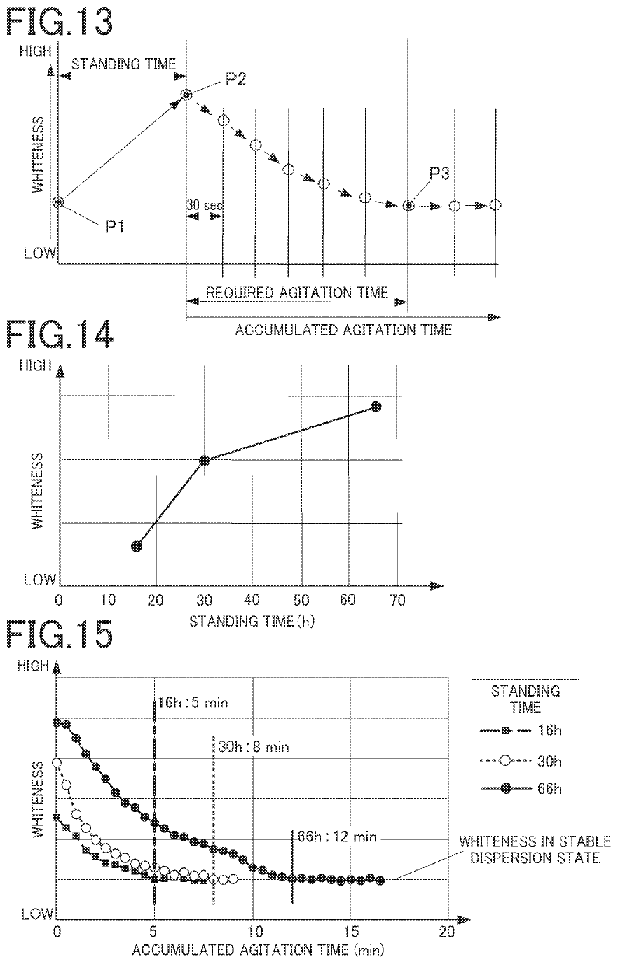

FIG. 14 is a graph to explain the relationship between the standing time and the change in whiteness.

As shown in FIG. 14, the longer the standing time is, the higher the whiteness is. That is, the separation in the liquid ink 50 and sedimentation of the component 50b proceeds as the cartridge 5 is kept standing. When the cartridge 5 that contains the white undercoat ink 50 as the liquid and that has been kept standing is used for printing, the ejected ink has a higher density of white ingredients than a desired density. This is because the component 50b as the white ingredient (e.g., titanium oxide) has settled at the bottom of the cartridge 5. As a result, the white color becomes thicker (higher whiteness).

As shown in FIG. 14, the experiment showed that sedimentation of the component 50b rapidly proceeded after around 10 hours to around 30 hours elapsed from the initial point P1 as 0 (zero) hour, at which the ink 50 was in the stable dispersion state. The experiment also showed that, after 30 hours elapsed, sedimentation proceeded relatively slowly and the whiteness of the printing result gradually increased along with the passage of time.

FIG. 15 is a graph showing the relationship between the agitation time and the change in whiteness for different standing times. In the experiment shown in FIG. 15, the rotation speed of the placing surface 21a (rotation speed of the motor 31) was kept at 10 rpm.

As shown in FIG. 15, when the standing time was short (e.g., 16 hours in FIG. 15), the degree of sedimentation of the component 50b was relatively low and the whiteness was not so high.

In the case, the component in the ink 50 as the liquid was redispersed after about 5 minutes of agitation, as shown by the vertical alternate long and short dash line in the figure. The required agitation time until the whiteness of the printing result became the whiteness in the stable dispersion state was 5 minutes.

When the standing time was 30 hours, sedimentation of the component 50b proceeded and the whiteness increased for the extended standing time.

In the case, the component in the ink 50 was redispersed after about 8 minutes of agitation, as shown by the vertical dotted line in the figure. The required agitation time until the whiteness of the printing result became the whiteness in the stable dispersion state was 8 minutes.

When the standing time was 66 hours, sedimentation of the component 50b proceeded and the whiteness increased for the extended standing time.

In such a case, the component in the ink 50 as the liquid was redispersed after about 12 minutes of agitation, as shown by the vertical solid line in the figure. The required agitation time until the whiteness of the printing result became the whiteness in the stable dispersion state was 12 minutes.

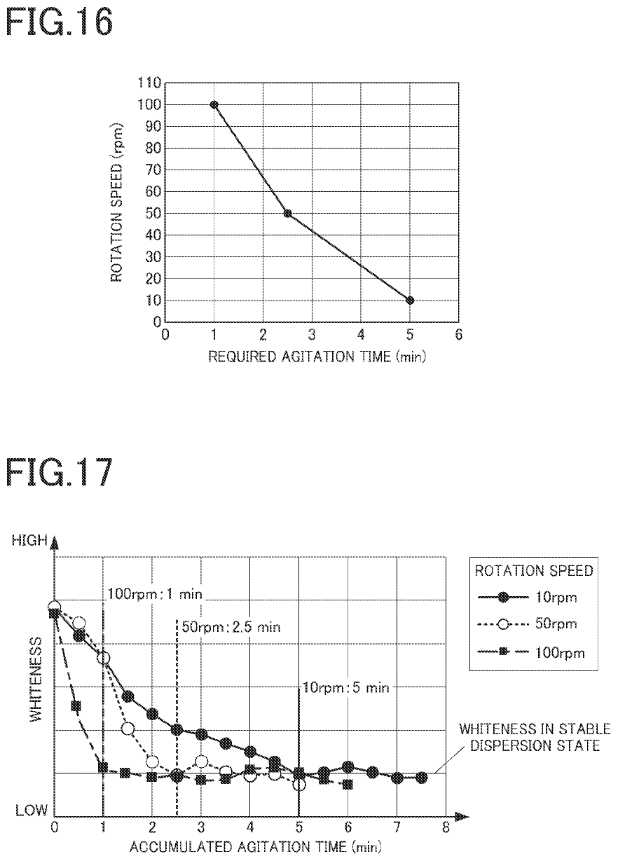

FIG. 16 is a graph showing the relationship between the rotation speed and the required agitation time.

As shown in FIG. 16, the experiment showed that the greater the rotation speed was, the more the agitation was accelerated, and the shorter the required agitation time was until the whiteness of the printing result became the whiteness in the stable dispersion state.

As described above, a greater rotation speed accelerates the agitation. A too great rotation speed, however, increases the risk of damaging the structure of the cartridge 5. Moreover, too intense agitation may generate air bubbles in the ink 50 in the cartridge 5 and cause poor ink ejection and poor printing result, regardless of separation or sedimentation of the component 50b. It is therefore preferable that a certain upper limit be set for the rotation speed. The upper limit may be determined appropriately on the basis of the type of the ink 50 (liquid) or the structure of the cartridge 5.

FIG. 17 is a graph showing the relationship between the agitating time and the change in whiteness for different rotation speeds. In the experiments and measurements of FIG. 17, the standing time was kept at 16 hours.

As shown in FIG. 17, the agitation effect becomes greater for a greater rotation speed (e.g., 100 rpm in FIG. 17) and the sedimented component 50b dissolves in a shorter period of time.

The component in the ink 50 was redispersed after about 1 minute of agitation, as shown by the vertical alternate long and short dash line in the figure. The required agitation time until the whiteness of the printing result became the whiteness in the stable dispersion state was 1 minute.

When the rotation speed is not so high (e.g., 50 rpm in FIG. 17), the time required for dissolving the sedimented component 50b becomes longer.

The component in the ink 50 (liquid 9 was redispersed after about 2.5 minutes of agitation, as shown by the vertical dotted line in the figure. The required agitation time until the whiteness of the printing result became the whiteness in the stable dispersion state was 2.5 minutes.

When the rotation speed is low (e.g., 10 rpm in FIG. 17), the time for dissolving the sedimented component 50b becomes further longer.

The component in the ink 50 was redispersed after about 5 minutes of agitation, as shown by the vertical solid line in the figure. The required agitation time until the whiteness of the printing result became the whiteness in the stable dispersion state was 5 minutes.

As described above, the required agitation conditions (herein, the rotation speed and agitation time) for proper redispersion in the ink 50 (liquid) depend on the relationship between the standing time of the cartridge 5 and the respective agitation conditions (rotation speed and agitation time).

When the standing time of the cartridge 5 is known, the agitation conditions to solve the separation and sedimentation in the cartridge 5 caused by the standing time are appropriately determined by combining various conditions, such as the rotation speed and agitation time.

For example, the agitation speed (rotation speed) is determined on the basis of the standing time of the cartridge 5 and the next printing timing with the cartridge 5.

For example, when the cartridge 5 has been kept standing for 16 hours and is to be used immediately for next printing, the rotation speed is set high (e.g., 100 rpm) in order to redisperse the component in a short period of time (e.g., 1 minute).

For another example, assume that: the cartridge 5 has been kept standing for a long time and the component in the ink 50 in the cartridge 5 has completely separated and sedimented; and the cartridge is to be used for printing next day. In the case, the rotation speed is set low (e.g., 10 rpm or lower) so that the component is redispersed over a long period of time (e.g., one night) until the printing next day.

In setting the agitation conditions, specific numerical values (e.g., rotation speed, agitation time) may not be input.

For example, in determining appropriate agitation conditions on the basis of the standing time of the cartridge 5 (elapsed time after the last printing), the user may input the standing time of the cartridge 5 with the operation receiver 11 or select the closest standing time from among multiple options. Then the agitation device 100 (e.g., the motor controller 33) may automatically determine the agitation conditions (e.g., rotation speed, agitation time) required for redispersion in the liquid (ink 50 in this embodiment).

The agitation conditions thus can be appropriately determined even when the user does not know a specific rotation time and agitation time required for redispersion.

Further, the agitation device 100 may be capable of communicating with external devices, such as a printing device, and automatically obtaining the standing time of the cartridge 5. On the basis of the obtained standing time, the motor controller 33 may automatically determine appropriate agitation conditions, for example.

In the case, the motor controller 33 serves as a setting receiver. Such an agitation device 100 determines appropriate agitation conditions without receiving any input by the user, and performs the required agitation process for redispersion.

When the agitation device 10 (e.g., motor controller 33) automatically determines the agitation conditions required for redispersion (e.g., rotation speed and agitation time) as described above, at least one memory of the device stores parameters or a table of the agitation conditions on the basis of the above-described experimental results. The motor controller 33 refers to these parameters/table and determines appropriate agitation conditions.

The operation receiver 11 may have a mode selection receiver that allows the user to select modes, such as “rapid redispersion” or “slow and quiet redispersion”. According to the selected mode, the motor controller 33 may determine the agitation conditions.

When the user determines the date and time of future printing, the agitation device 100 may determine agitation conditions on the basis of the table storing standing times and agitation conditions so that the ink is in optimum state at the time of printing.

The agitation device 100 that allows mode selection as described above can perform the agitation process that better meets the user's needs.

The agitation process is performed on the basis of the determined agitation conditions, so that the component in the liquid ink 50 in the cartridge 5 is redispersed.

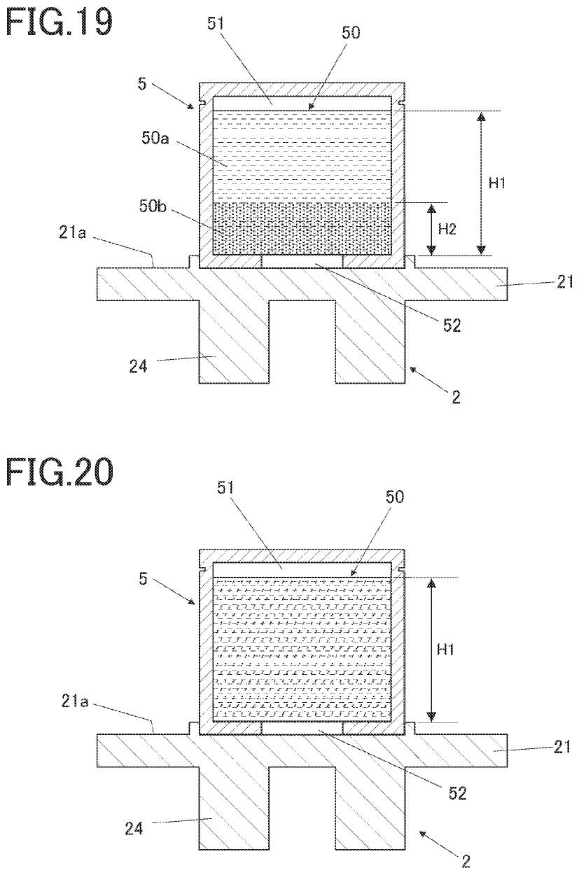

FIG. 18 is a side section of the main parts of the agitation device 100 in operation in this embodiment. FIG. 19 is a section of the main parts of the holder 2 holding the cartridge 5 before agitation. In FIGS. 18, 19, H1 indicates the level of the entire liquid ink 50. In FIG. 19, H2 indicates the level of the component 50b that has separated from the medium 50a and sedimented.

As a result of agitation under the agitation conditions, the separation and sedimentation in the ink 50 shown in FIGS. 18, 19 is cleared and the component 50b mixes with the medium 50a. Accordingly, the entire ink 50 (liquid) is in the redispersion state in which the component 50b is dispersed substantially evenly in the ink 50, as shown in FIG. 20.

The cartridge 5 after undergoing the agitation process is set on a printer and allows printing with an adequate ink density. The ink 50 is less likely to cause poor ink ejection by clogging nozzles. The printer can perform high quality printing.

As described above, according to the above embodiment, the agitation device 100 includes: the holder 2 that holds the cartridge 5 containing the liquid ink 50 on the placement surface 21a angled with respect to the horizontal surface Hp; and the rotator 3 that rotates the holder 2 so as to agitate the liquid, in which the component 50a sediments in the medium 50b as the liquid is left standing.

When the relative density of the component 50b (e.g., titanium oxide) in the liquid ink 50 is greater than the relative density of the medium 50a (e.g., water), the component 50b gradually separates from the medium 50a and sediments in the medium 50a as the ink 50 is left standing. The ink 50 in which the sedimentation proceeded may clog the nozzles through which the ink 50 is ejected and cause poor ink ejection in printing. The ejected ink 50 may also contain a higher proportion of the component 50b than an adequate proportion and produce a thicker ink color. The variation in ink density may result in low printing quality, such as uneven colors and lateral stripes in the print.

In this regard, the agitation device 100 in this embodiment rotates the cartridge 5 on the angled placing surface 21. Through rotation and swinging, the ink 50 (liquid) in the cartridge 5 can be effectively agitated.

Even when the liquid is the undercoat ink 50 that is applied before design printing (nail printing) and that contains titanium oxide as the component 50b, the agitation device 100 appropriately disperses the component in the ink 50 and enables high quality printing.

The user may find it physically hard to shake the cartridge manually in order to redisperse the component in the ink 50 (liquid). The user may also find it difficult to properly grasp how much agitation is required. Different physical abilities between individuals (e.g., speed of swinging arms and physical strength) may result in different degrees of agitation. Agitation may be insufficient or excessive, so that the degree of redispersion is not stable.

In this embodiment, the agitation device 100 automatically agitates the ink 50 (liquid). This allows stable and appropriate redispersion.

According to this embodiment, the agitation device 100 further includes the operation receiver 11 that functions as a setting receiver capable of setting at least either the rotation speed at which the rotator 3 rotates the holder 2 or the agitation time.

It turned out that the higher the rotation speed of the holder 2 (rotation speed of the motor 31) is, the higher the agitation effect is. It also turned out that the longer the agitation time is, the more secure the agitation effect is.

The agitation device 100 in this embodiment includes the operation receiver 11 with which the user can set the agitation conditions (e.g., rotation speed and agitation time). The agitation device 100 can therefore perform the agitation process that better meets the user's needs. For example, the user may require swift redispersion in the ink 50 (liquid) or may require steady redispersion even if that takes a long time.

According to this embodiment, the agitation device 100 can set at least either the rotation speed at which the rotator 3 rotates the holder 2 or an agitation time, based on a degree of sedimentation of the component 50b in the cartridge 5.

The longer the standing time of the cartridge 5 is, the further the separation and sedimentation of the component of the ink 50 (liquid) proceeds in the cartridge 5. The further the separation and sedimentation in the ink 50 (liquid) proceeds, the higher rotation speed or the longer agitation time is required for redispersion.

In this embodiment, the agitation device 100 can set appropriate agitation conditions on the basis of the degree of sedimentation of the component 50b and the standing time of the cartridge 5. Thus, the agitation device 100 can effectively solve the separation and sedimentation in the ink and redisperse the component in the ink 50 (liquid).

Although the embodiment of the present invention has been described, the present invention is not limited to the above-described embodiment and can be variously modified without departing from the scope of the invention.

For example, in the embodiment, the agitation conditions, such as the rotation speed at which the rotator 3 rotates the holder 2 and the agitation time, are determined considering the standing time of the cartridge 5. However, the factor for determining the agitation conditions is not limited to the standing time.

For example, the quantity of the remaining ink 50 (liquid) in the cartridge 5 may be taken into account for determining the agitation conditions.

When the quantity of the remaining ink 50 is small, the rotation speed may be lowered or the agitation time may be shortened, for example.

When the ink 50 (liquid) in the cartridge 5 is apt to bubble up by intense agitation movements, the rotation speed may not be increased even after the cartridge 5 has been left standing for a long time. Instead, the agitation time may be extended.

Further, the cartridge 5 may have a window through which the ink 50 (liquid) contained therein is visible. The agitation conditions including the rotation speed and the agitation time may be determined on the basis of the state inside the cartridge 5.

The user may visually check the state inside the cartridge 5 and input the degree of separation/sedimentation or the agitation conditions on the basis of these degrees by operating the operation receiver 11, for example.

The window may be provided such that the top clear layer of the ink 50 (liquid) is visible. Further, a measurer that can measure the transparency and whiteness of the ink 50 (liquid) may be provided at the position corresponding to the window. The degree of separation/sedimentation in the ink 50 (liquid) obtained by the measurer may be automatically reflected on the setting of the agitation conditions.

Although the liquid to be agitated in this embodiment is the undercoat ink 50, the liquid is not limited to the undercoat ink.

The liquid is not limited to inks. Examples of liquid widely include a liquid that contains the medium 50a and the component 50b being apt to separate and sediment and that may not be properly used when the separation/sedimentation occurs.

It is not essential to set the agitation conditions including the rotation speed at which the rotator 3 rotates the holder 2 and the agitation time.

As long as the placing surface 21a is angled and rotated, any configuration is applicable. The agitation conditions may be kept unchanged regardless of factors, such as the standing time of the cartridge 5.

In the embodiment, the main body 1 has an angled surface, and the holder 2 is placed substantially horizontal to the angled surface, as shown in FIG. 18. However, the configuration of the agitation device 100 is not limited to the illustrated example.

The main body 1 of the agitation device 100 may not have an angled surface, as long as the placing surface 21a of the holder 2 for holding the cartridge 5 is angled at a certain angle (e.g., 45 degrees) with respect to the horizontal surface Hp.

Further, the agitation device 100 may apply vibrations or the like to the liquid in addition to the rotation in the angled state. For example, the agitation device 100 may include an actuator or an ultrasonic vibrator that vibrates the placing surface 21a and transmits vibrations to the cartridge 5 held on the holder 2.

Although one or more embodiments of the present invention have been described, the scope of the present invention is not limited to the above-described embodiment but includes the scope of claims and the scope of their equivalents.

What is claimed is:

1. An agitation device comprising:
a holder that holds a cartridge containing a liquid on a placement surface angled with respect to a horizontal plane; and
a rotator that rotates the holder to agitate the liquid.

2. The agitation device according to claim 1, further comprising at least one processor that sets at least either a rotation speed at which the rotator rotates the holder or an agitation time, based on a degree of sedimentation of a component of the liquid contained in the cartridge.

3. The agitation device according to claim 2, further comprising a memory that stores agitation conditions with respect to each time during which the liquid is left standing, the agitation conditions being related to the rotation speed and the agitation time, wherein
the processor determines at least either the rotation speed or the agitation time, based on the agitation conditions stored in the memory.

4. The agitation device according to claim 1, wherein
the liquid includes titanium oxide as a component and is an undercoat ink that is applied before a design is printed.

5. The agitation device according to claim 1, wherein the cartridge includes a window through which the liquid in the cartridge is visible from outside.

6. An agitation method comprising:
holding, with a holder, a cartridge containing a liquid on a placement surface angled with respect to a horizontal plane; and
rotating, with a rotator, the holder to agitate the liquid.

7. The agitation method according to claim 6, further comprising:
setting at least either a rotation speed at which the rotator rotates the holder or an agitation time, based on a degree of sedimentation of a component of the liquid contained in the cartridge,
wherein in the rotating, the rotator rotates the holder at the set rotation speed for the set agitation time.

8. The agitation method according to claim 6, further comprising setting at least either a rotation speed at which the rotator rotates the holder or an agitation time, based on a time during which the liquid is left standing.
